(19) United States
(12) Patent Application Publication
(10) Pub. No.: US 2006/0153454 A1
(43) Pub. Date: Jul. 13, 2006

(54) Method for alignment of a graphic object on a overview image of a subject

(75) Inventor: Andreas Grimme, Erlangen (DE)

Correspondence Address: SCHIFF HARDIN, LLP;PATENT DEPARTMENT, 6600 SEARS TOWER, CHICAGO, IL, 60606-6473, US

(73) Assignee: Siemens Aktiengesellschaft

(21) Appl. No.: 11/328,584

(22) Filed: Jan. 10, 2006

(30) Foreign Application Priority Data
Jan. 11, 2005 (DE) 10 2005 001 325.2

(51) Int. Cl. G06K 9/00

(52) U.S. Cl. 382/181

(57) ABSTRACT

In a method for alignment of a graphic object on an overview image of a subject (in particular of a body part of a patient) shown on a display screen, a graphic object establishes parameters for a subsequent imaging of at least parts of the subject; and an input device allows positioning of the graphic object on the overview image; with characteristic data that describe a type and a position of at least one characteristic pattern in the overview image upon which the graphic object is aligned. Given a position of the graphic object on the screen that is predetermined by the input device, a check is made as to whether the graphic object is located in an alignment region of the characteristic pattern in which an automatic alignment of the graphic object relative to the characteristic pattern can be implemented. An automatic alignment of the graphic object to the characteristic pattern if the graphic object is located in this alignment region.

### BACKGROUND OF THE INVENTION

1. Field of the Invention

The present invention concerns a method for alignment of a graphic object on an overview image of a subject, of the type wherein a graphic object establishes parameters for subsequent imaging of at least parts of the subject, and wherein an input device allows positioning of the graphic object on the overview image with characteristic data that describe a type and a position of at least one characteristic pattern in the overview image upon which the graphic object is aligned.

2. Description of the Prior Art

In medical diagnostics and radiology, new slices to be measured are planned based on already-acquired images of a patient with a technique known as graphical slice positioning (GSP) for preparation of, for example, magnetic resonance imaging of a body part to be examined. One or more overview images or reference images of the body part of the patient to be examined are initially acquired with the magnetic resonance tomography apparatus and are shown on a display screen.

In detail, various graphic objects that are used for graphical description and for definition of the subsequent imaging are used for the various functions of the graphical slice positioning. For planning the actual (diagnostic) imaging, the operator aligns corresponding graphic objects in the three-dimensional patient space (represented by one or more overview images) to specific anatomical features of the patient. Examples of such patient features are vertebral bodies and intervertabral discs in spinal column examinations, the short and long axes of the heart in heart examinations, aorta bifurcation in vessel examinations, characteristic bone shapes in joint examinations, and the lung-liver boundary layer for the positioning of navigators.

For optimal graphical representation of an organ, the corresponding graphic objects must be precisely aligned in all six degrees of freedom (three for translation and three for rotation). For this purpose the user roughly positions the graphic objects with a mouse using the anatomical features to be shown in the overview image. For example, in the event that additional geometric information about the anatomy of the patient is present from earlier measurements, the operator can also have the graphic object automatically align with an automatic alignment reference that is selected (set) as via a menu item. For example, a measurement slice in the longitudinal direction of a vertebral body or an intervertabral disc can be automatically, precisely aligned in spinal column examinations if the graphic object is located in the alignment region of the alignment reference . If the graphic object is not located in the alignment region of the alignment reference, the operator must realign the graphic object and in turn activate the alignment reference via a menu item.

The function of the graphical slice positioning described above can also be used to define specific slices in an already-acquired 3D image data set for an image representation. The procedure corresponds to that described above, with the exception that no measurement parameters can be established.

### SUMMARY OF THE INVENTION

An object of the present invention is to simplify for the user the procedure for alignment of a graphic object on an overview image.

This object is achieved in accordance with the invention in a method of the type initially described wherein a position of the graphic object on the screen is changed by an input device, with a check being made as to whether the graphic object is located in an alignment region of the characteristic pattern in which an automatic alignment of the graphic object can be implemented with regard to the characteristic pattern. In the event that the graphic object is located in such an alignment region, an automatic alignment of the graphic object to the characteristic pattern ensues. An imaging of the subject then ensues dependent on the position and alignment of the graphic object as well as dependent on further control data that are established by the graphic object.

The check as to whether the graphic object is located in the alignment region of the alignment automatic preferably ensues in real time, i.e. constantly or frequently, such that the position predetermined by the input device does not deviate too significantly between two successive checks.

In an embodiment, the normal position of the graphic object is established again as soon as the graphic object is shifted again from the alignment region of the alignment automatic with the input device.

### DESCRIPTION OF THE DRAWINGS

FIG. 1 is a flowchart of the basic method for alignment of a graphic object in a medical image data set in accordance with the invention.

FIG. 2 is a flowchart for an automatic alignment reference in accordance with the invention.

FIG. 3 schematically illustrates the automatic alignment of imaging slices in a medical data set in accordance with the invention.

### DESCRIPTION OF THE PREFERRED EMBODIMENTS

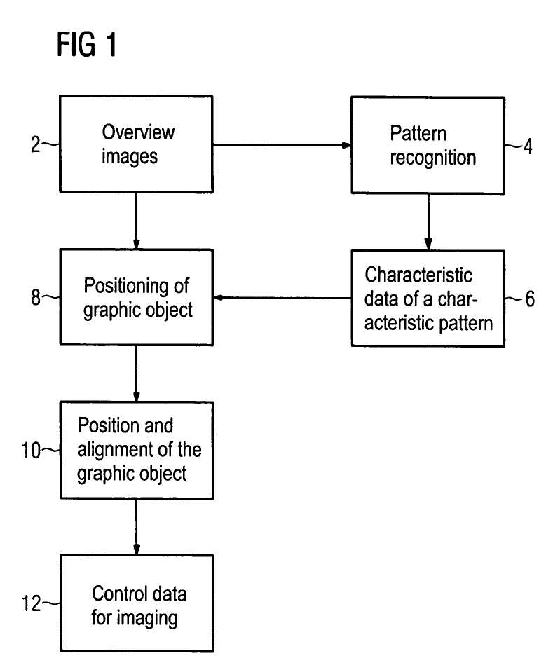

The method (the basic steps being shown in FIG. 1) for alignment of a graphic object on an overview image of a subject has the goal of interactively supporting a user for positioning slices in a graphical slice positioning for planning measurements, or in a 3D construction from an already-acquired 3D image data set. The method is used in the generation and display of medical 3D image data sets that will be generated or were generated by magnetic resonance. The basic functions of the graphical slice positioning already have been described above.

In the overview image shown in FIG. 1, control parameters for subsequent imaging are to be determined from the positioning of a specific graphic object on one or more overview images. For this purpose, a series of overview images or reference images 2 is initially acquired that enable a user to orient himself or herself as to the anatomy of a patient or in a three-dimensional patient space. The overview images 2 simultaneously serve as input data for a pattern recognition method 4 that automatically establishes the type and position of anatomical features in the image data. Such anatomical features are, for example, vertebral bodies or intervertabral discs in spinal column examinations, the short and long axes of the heart in heart examinations, the aorta bifurcation (for example) in vessel examinations, typical bone shapes in joint examinations and the lung-liver boundary layer that should be detected by a navigator in liver imaging. The anatomical features each possess a characteristic pattern that can be described by characteristic data 6. In addition to the type of the pattern (such as, for example, ellipses given an intervertabral disc), the characteristic data 6 also represent the position of the pattern.

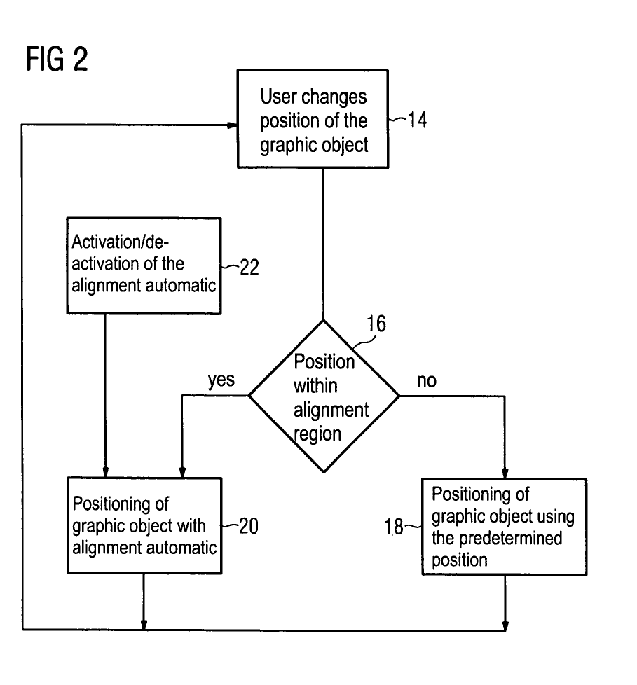

The overview images 2 as well as the data regarding the type and position of the anatomical features 6 are now supplied to a graphical slice positioning 8. The graphical slice positioning 8 interactively supports an automatic positioning of the corresponding graphic object, as is subsequently described in detail using FIG. 2. After the graphic object is aligned relative to the anatomical feature, data regarding the position and alignment of the graphic object are output from the graphical slice positioning 8 in the method step 10, from which data control data 12 are then formed for a subsequent imaging. Dependent on the graphic object, in the case of the measurement planning the control data 12 specify position and alignment of a slice to be measured in the subject or multiple slices to be measured in the subject. However, the control data 12 can also establish saturation regions, the position of navigator signals or the like in the body of the patient. In the case of 3D reconstruction of specific slices from an already-acquired 3D image data set. The control data provide the position and alignment of a slice to be represented.

FIG. 2 shows the fundamental functionality of the interactive support in the positioning of graphic elements. Starting from a change of the position of the graphic object on an overview image 14 that the user effects with the aid of a corresponding input device (such as, for example, a computer mouse), in a decision step 16 it is established by means of a suitable heuristic whether the position of the graphic object lies within an alignment region of an anatomical feature or not.

In the exemplary embodiment, the alignment region in the image plane visible to the user is established as follows. The (generally three-dimensional) graphic object and the anatomical feature in the three-dimensional patient space on which it is aligned are projected into the shown image plane. The alignment region is a circle with a specific radius measured in pixels around the center point of the anatomical feature. A radius of 32 pixels has proven to be practical. Unchanged, the alignment region thereby amounts to 32 pixels in the visible image, independent of an adjusted scaling of the image data. In the case of high magnifications, this would otherwise lead to the entire visible region being covered (overlapped) by the alignment region.

The further workflow ensues corresponding to the result of the decision step 16. If the position of the graphic object is outside of the alignment region, the positioning on the overview image then ensues according to method step 18 using the position predetermined by the input device. However, if the position of the graphic object lies within the alignment region, the alignment automatic then aligns the graphic object in the method step 20 corresponding to predetermined rules.

The rules for the automatic alignment are predetermined by the subsequent imaging: the alignment automatic alters position and orientation of the graphic object in three-dimensional space such that the subsequent medical imaging described by the graphic object optimally (according to radiological points of view) shows the anatomical feature or also the characteristic pattern. The optimal representation depends on the respective anatomical feature. In the example of imaging of the intervertabral discs, the position of the slice group is to be selected such that the intervertabral discs, the vertebral bodies, the vertebral arches and the nerve root exit openings are shown axially symmetrical. The average value of the inclinations of both vertebral body end plates abutting the intervertabral disc is selected as an inclination of the slice group.

To improve the orientation for the user, the geometric information (position and alignment of the graphic object) that results from the automatic alignment is additionally shown (inserted) in the graphical slice positioning.

The interrogation of the position is constantly repeated in real time in order to optimally support the interactive positioning by the user. The user can temporarily deactivate the interactive alignment automatic with the input option 22. The input possibility 22 can be realized by a specified button on the mouse or the keyboard or via an input field in a menu.

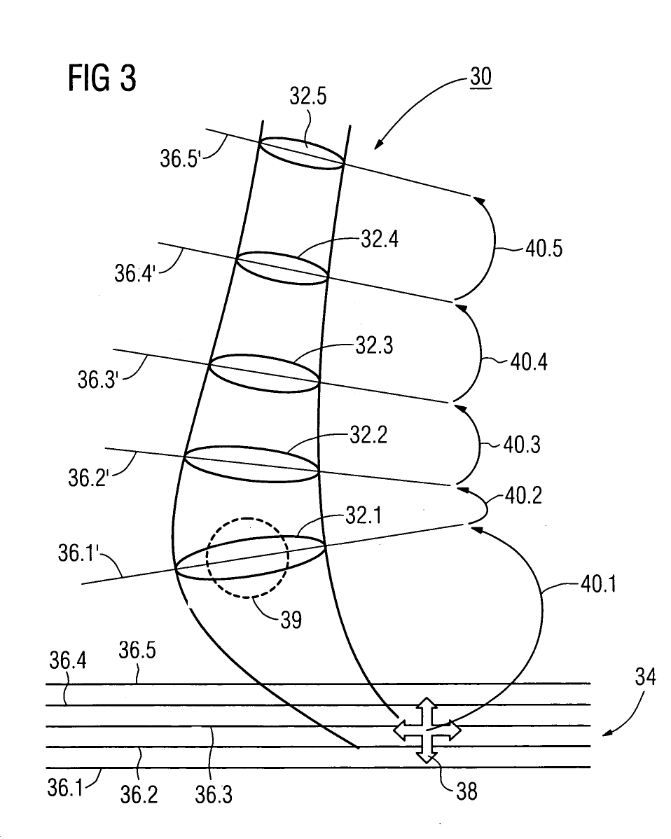

The functionality of the interactive positioning that is made available to the user on the screen, as explained using FIG. 3. Schematically shown in FIG. 3 is a region of a spinal column 30 with five intervertabral discs 32.1 through 32.5 that all exhibit a different alignment in three-dimensional patient space. A graphic object 34 (here a slice block with five individual slices 36.1 through 36.5) is now displaced over the overview image of the spinal column 30 with an input device. The position predetermined by the input device is marked with a cursor 38. The characteristic data 6 that describe the type and position of the individual intervertabral discs 32.1 through 32.5 have been previously determined with the aid of the pattern recognition method 4, or are known through corresponding user inputs to the alignment automatic.

Using the input device and the visible position of the cursor 38, the graphic object 34 (thus the entire slice block with the individual slices 36.1 through 36.5) is now displaced over the overview image until its position is located within the alignment region of the lower intervertabral disc 32.1. The alignment automatic now positions the lowermost slice 36.1 in the slice block at the intervertabral disc 32.1, corresponding to predetermined rules. The alignment region is demarcated by a circle 39 (plotted dashed), although it is not actually visible for the operator. The aligned and positioned slice is identified in FIG. 3 with the reference character 36.1. The first displacement path is symbolized by the curved arrow 40.1. If the cursor 38 is displaced further upwardly (symbolized by the curved arrow 40.2) until it is detected by the alignment region of the second intervertabral disc 32.2, the second slice 36.2 in the slice block 34 is positioned and aligned corresponding to the intervertabral disc 32.2. The aligned second slice is identified with the reference character 36.2. The further positioning along the cursor paths 40.3, 40.4 and 40.5 then results corresponding to the aligned slices 36.3′, 36.4′, and 36.5′. The position data of the aligned slices 36.1′ through 36.5′ are then used for a subsequent imaging or also for representation of the corresponding slices from an already-generated 3D image data set.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for aligning a graphic object on an overview image of a medical examination subject on a display screen, comprising the steps of:
displaying an overview image of an examination subject on display screen with characteristic data describing a type and a position of at least one characteristic pattern in the overview image;
through an input device that interacts with said display screen, placing a graphic object, that establishes parameters for subsequent imaging of at least portion of said examination subject, at a predetermined position on said overview image; and
in a computer that interacts with said display screen, automatically electronically checking whether said graphic object, at said predetermined position, is located in an alignment region relative to said characteristic pattern that allows an automatic alignment of said graphic object to said characteristic pattern and, if so, automatically electronically aligning said graphic object relative to said characteristic pattern.

2. A method as claimed in claim 1 comprising, in said computer, constantly repeatedly checking whether the position of said graphic object predetermined via said input device is located in said alignment region.

3. A method as claimed in claim 1 comprising automatically electronically cancelling said automatic alignment of said graphic object relative to said characteristic pattern if said graphic object is moved out of said alignment region via said input device.

4. A method as claimed in claim 1 comprising, through said computer, allowing temporary deactivation of said automatic alignment.

5. A method as claimed in claim 1 comprising displaying geometric information on said display screen relating to said automatic alignment of said graphic object.

6. A method as claimed in claim 1 comprising displaying an anatomical slice image of the examination subject as said overview image.

7. A method as claimed in claim 6 comprising displaying, as said graphic object, a graphic element that describes a further slice in the examination subject to be obtained in said subsequent imaging.

8. A method as claimed in claim 1 comprising displaying an image of a spinal column of the examination subject as said overview image, and employing, as said characteristic pattern, a characteristic pattern representing an intervertabral disc of a spinal column.
